(19) United States
(12) Patent Application Publication
(10) Pub. No.: US 2011/0240281 A1
(43) Pub. Date: Oct. 6, 2011

(54) Liquid-Based Cooling System For Data Centers Having Proportional Flow Control Device

(75) Inventor: Randall N. Avery, Bogart, GA (US)

(73) Assignee: Industrial Idea Partners, Inc.

(21) Appl. No.: 12/751,916

(22) Filed: Mar. 31, 2010

(51) Int. Cl. G05D 23/00; F25B 13/00; F25B 15/00

(52) U.S. Cl. 165/287; 62/324.1; 62/476; 165/80.2

(57) ABSTRACT

A liquid-based cooling system provides a method of supplying a heated coolant fluid at a relatively constant temperature and pressure to one or more heat driven engines, such as adsorption chillers or heat pumps, by utilizing a proportional flow control device in association with each of a plurality of heat-producing electronic components to optimize the output of a plurality of liquid-cooled cold plates operatively mounted on such plurality of heat-producing electronic components. The proportional flow control devices may be electro-mechanical or solid state proportional control valves for water flow control. The proportion flow control devices are operatively connected to be actuated based upon the electrical signals typically generated to control the variable cooling fans of the electronic components.

### CROSS-REFERENCE TO RELATED APPLICATION

This application contains subject matter which is related to the subject matter of U.S. patent application Ser. No. 12/606,895 entitled “Utilization of Data Center Waste Heat for Heat Driven Engine,” by Avery, et al., which is assigned to the same assignee and which is incorporated herein by reference in its entirety.

### BACKGROUND OF THE INVENTION

This invention relates generally to increasing the efficiency of energy utilization of data centers. Specifically, this invention relates to an improved liquid-based cooling system for cooling a multi-component electronics system which generates an output fluid at a substantially constant pressure and temperature. By generating an output fluid of a data center cooling system at a substantially constant pressure and temperature, the output fluid is optimized for use as the driving heat for driving a heat driven engine, such as a heat driven chiller or heat pump.

Data centers are well known in the art for housing a collection of computer servers and associated equipment. The cooling of such electronics systems presents a challenge for most facilities and the energy consumed in cooling such data centers represents a significant and growing portion of the total energy consumption of a facility.

Pending U.S. patent application Ser. No. 12/606,895 entitled “Utilization of Data Center Waste Heat for Heat Driven Engine,” by Avery, et al., discloses a method and system of utilizing waste heat from a data center. A cooling fluid, such as water, is pumped across a plurality of data center equipment and the heat carried away from the equipment by the cooling fluid is used as the heat input for driving a heat driven engine, such as an adsorption chiller or heat pump.

The present invention is directed towards providing a more constant and controlled source of driving heat for a heat driven engine (adsorption chiller or heat pump). The present invention incorporates one or more proportional control valves into the fluid-carrying cooling system to regulate the temperature and pressure at which the heated coolant is output.

A prior art data center cooling system is illustrated by U.S. Pat. No. 7,420,808 entitled “Liquid-Based Cooling System For Cooling A Multi-Component Electronics System,” by Campbell, et al. (the “'808 Patent”). The '808 Patent discloses a monolithic structure preconfigured for cooling multiple electronic components of an electronics system. The structure includes multiple liquid-cooled cold plates configured and disposed in spaced relation to couple to respective electronic components, a plurality of coolant-carrying tubes metallurgically bonded in fluid communication with multiple liquid-cooled cold plates, and a liquid-coolant header subassembly metallurgically bonded in fluid communication with multiple coolant-carrying tubes. The header subassembly includes a coolant supply header welded to coolant supply tubes and a coolant return header welded to coolant return tubes. The monolithic structure for each server comprises a single coolant inlet and a single coolant outlet extending from the header subassembly for coupling to the electronics rack's coolant supply and return manifolds. The liquid-based cooling system disclosed in the '808 Patent removes heat from the electronics system by elevating the temperature of the liquid coolant as it passes through the cold plates. In the '808 Patent, the number of parallel paths and the number of series-connected liquid-cooled cold plates depends on the desired device temperature, available coolant temperature and coolant flow rate, and the total heat load being dissipated from each electronic component. '808 Patent, Col. 12, Lines 36-40.

The present invention incorporates one or more proportional control valves at either the individual server level or the individual electronic component level to optimize the regular flow of heated cooling fluid at a desired, relatively constant temperature and pressure, in order to increase the efficiency of the operation of the heat driven engine.

A data center, sometimes called a server farm, is a facility used to house computer systems and associated components, such as telecommunications and storage systems. It may be an entire building, a single room, or one or more floors or other separate portions of a building. In addition to computer systems and associated components, data centers typically house one or more redundant backup power supplies, redundant data communications connections, environmental controls (e.g., air conditioning systems, fire suppression systems) and security devices.

Adequate environmental controls are a priority for data centers because such systems must continually provide environmental conditions suitable for the computer and server equipment used to store and manipulate a business' electronic data and information systems.

As the amount of equipment in a data center increases, and as the number computations or operations per electronic component increase and the speed of individual components increase, the chips and other heat-generating electronic components will generate increasing amounts of waste heat. Growth in the size, complexity and sophistication of data centers and the components housed therein have required correspondingly larger and more powerful air cooling and dehumidification systems to keep the data center and the equipment it houses sufficiently cool. Keeping an area and the devices within it cool can also be conceptualized as rejecting the heat generated by the equipment within the area out of the area, in this case, taking heat out of the data center.

This waste heat is typically disposed of by simply venting it to the atmosphere, either within or outside the data center, or dissipating it through an alternate heat sink such as a cooling tower. Co-pending patent application Ser. No. 12/606,895 discloses a novel application for capturing some of the energy available in this waste heat.

### BRIEF SUMMARY OF THE INVENTION

A liquid-based cooling system according to the present invention provides a system and method of more efficiently utilizing waste heat from a data center by supplying a heated coolant fluid, such as water, at a relatively constant temperature and pressure to one or more heat driven engines, such as adsorption chillers or heat pumps. A proportional flow control device is utilized in association with all or a portion of a plurality of heat-producing electronic components to optimize the output of a plurality of liquid-cooled cold plates operatively mounted on or engaged with such plurality of heat-producing electronic components. The proportional flow control devices may be electro-mechanical or solid state proportional control valves for water flow control. The proportion flow control devices are operatively connected to be actuated based upon the electrical signals typically generated to control the variable cooling fans of the electronic components. The proportional flow control devices are coordinated to provide a collective output flow of heated coolant fluid at a relatively constant temperature and pressure. Heat driven engines, especially adsorption chillers, operate more efficiently when driven by a heated fluid that is supplied at a relatively fixed temperature and pressure. Based on the number and capacity of heat driven engines, the proportional flow control devices of the present invention can be coordinated to achieve a continuous flow of heated coolant fluid at the temperature and pressure which will maximize the efficiency of operation of the heat driven engine or engines.

In one preferred embodiment, supplying a heated coolant fluid at a relatively stable. temperature and pressure has been found especially desirable for driving an adsorption chiller consisting of a sorbate-sorbent working pair, preferably a silica gel—water working pair adsorption chiller.

Currently, the heat output of a data center is generally considered only as waste heat which must be eliminated, typically by exhausting it directly to the atmosphere. The present invention increases the efficacy of a method of extracting useful work or output from this waste heat. The useful output of the heat engine adsorption chiller (cold water) or heat pump (rejected heat) can be used for a variety of useful purposes, such as the de-humidification and air conditioning required to cool the equipment within the data center.

It is therefore a purpose of the present invention to provide a liquid-based cooling system capable of generating a heated coolant fluid output having a relatively stable or constant temperature at a relatively stable and constant pressure.

It is a further object of the present invention to increase the efficiency of the heat driven engines which may be driven by the waste heat of the electrical components found in data centers.

### BRIEF DESCRIPTION OF THE DRAWINGS

The particular features and advantages of the invention as well as other objects will become apparent from the following description taken in connection with the accompanying drawings in which:

FIG. 1 is a front perspective view illustrating a typical server cabinet such as found in a data center.

FIG. 2 is a schematic representation of a rear perspective view of one embodiment of a server blade and associated frame-level circulation assembly according to the present invention.

FIG. 3 is a schematic representation of a rear view of a chassis having a chassis-level header assembly according to the present invention.

FIG. 4 is a schematic representation of a rear view of a typical server cabinet having a cabinet-level header assembly according to the present invention.

FIG. 5 is a schematic representation of a rear view of an alternative cabinet configuration having a plurality of server blades held horizontally within the cabinet and the associated alternative embodiment of a cabinet-level header assembly according to the present invention.

FIG. 6 is a schematic diagram of one embodiment of the liquid-based cooling system of the present invention.

### DETAILED DESCRIPTION OF THE INVENTION

Data centers and the multiplicity of types of electronics systems located therein are well known in the art. As used herein “electronics system” comprises any system containing one or more heat generating components of a computer system or other electronics unit requiring cooling. The terms “electronics rack,” “electronics frame,” “server cabinet,” and “frame” are used interchangeably, and include any housing, rack, compartment, blade chassis, etc., having heat generating components of a computer system or electronics system. In one embodiment, an electronics frame comprises multiple blade chassis, each chassis having multiple server blades, each server blade having multiple heat generating components disposed therein requiring cooling. “Blade chassis” refers to any sub-housing, electronics drawer, book, drawer, note compartment, etc., having multiple heat generating electronic components disposed therein.

“Electronic component” refers to any heat generating electronic component of, for example, a computer system or other electronics unit requiring cooling. By way of example, an electronic component may comprise one or more integrated circuit chips and/or other electronic devices to be cooled, including one or more processor chips, memory chips and memory support chips.

A “liquid-cooled cold plate” refers to any conventional thermally conductive structure having a plurality of channels or passageways formed therein for flowing of liquid coolant therethrough.

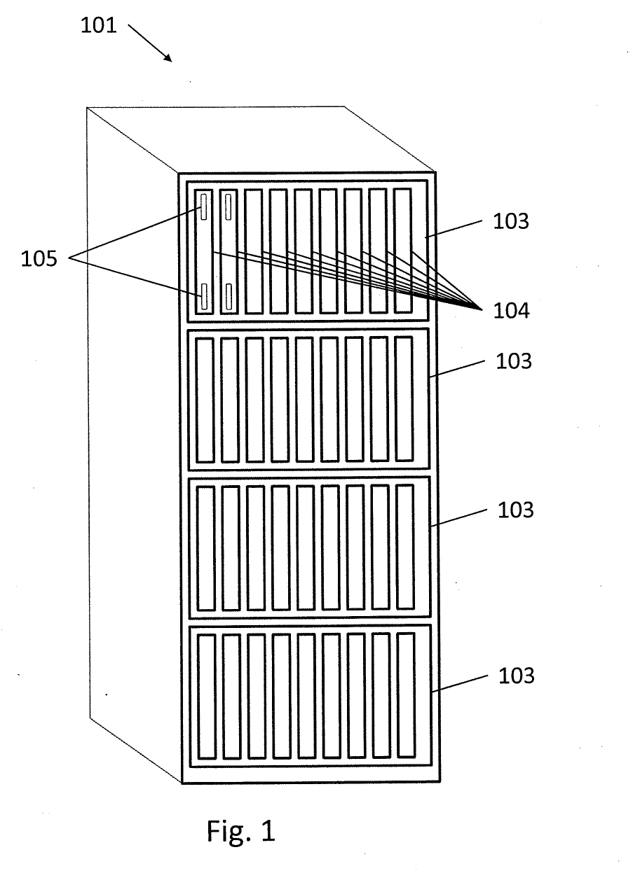

FIG. 1 illustrates a typical server cabinet 101 comprising one or more chassis 103, each chassis 103 having multiple server blades 104, each server blade 104 having multiple heat generating electronic components (not shown in FIG. 1) disposed therein. Server cabinets 101 generally have an open rear (not shown) to allow access for wires, power cords and other physical attachments to the server blades 104. Latches 105 or other connectors hold server blades 104 to the carrying chassis 103, and chassis 103 may be configured as drawers in the server cabinet 101. A typical data center will contain multiple server cabinets 101.

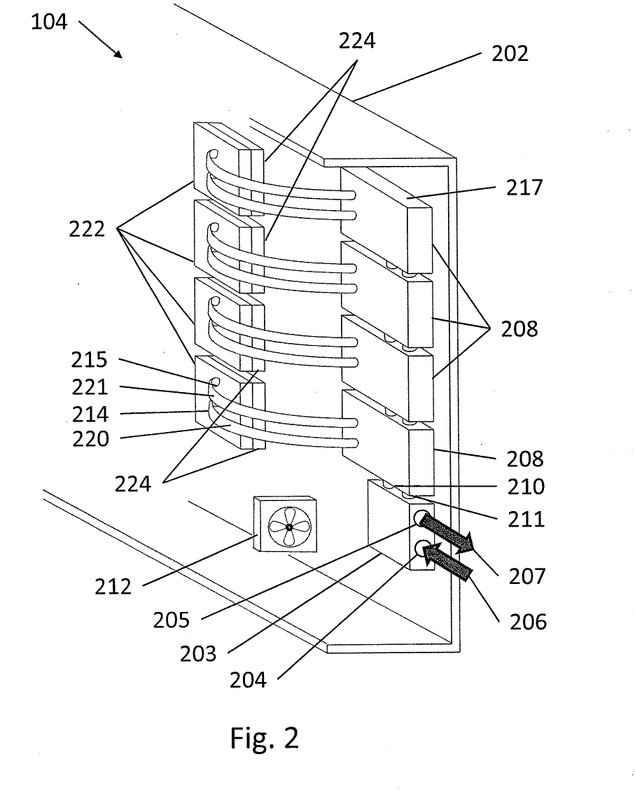

FIG. 2 is a schematic representation of a rear perspective view of one embodiment of a server blade 104 and associated frame-level circulation assembly 217 according to the present invention. A server blade 104 comprises a blade frame or housing 202 having multiple heat generating electronic components 224 disposed thereon. A liquid-cooled cold plate 222 is mounted on one or more electronic components 224, each liquid-cooled cold plate 222 having a fluid inlet port 214 and a fluid outlet port 215. In the embodiment shown in FIG. 2, a proportional flow control device 208 is connected in fluid communication with an associated cold plate 222 by an input connector tube 220 and an output connector tube 221. A proportional flow control device 208 may be any conventional device for controlling the flow of coolant entering or exiting the cold plate 222. In an embodiment not illustrated in FIG. 2, a proportional flow control device 208 may be connected to the associated cold plate 222 by only one of either the input connector tube 220 or the output connector tube 221 and continue to adequately serve the function of regulating the flow of coolant fluid through the cold plate 222.

In one preferred embodiment, the proportional flow control device 208 may comprise an electro-mechanical or solid state proportional control valve for water flow control. The proportional flow control device 208 is operatively connected to the electronics system, such as to the central processor (not shown) of the electronics system, to be actuated based upon the electrical signals used to control the one or more variable cooling fans 212 associated with each server blade 104. The practice, methods and means of controlling variable speed cooling fans 212 using temperature data collected, collectively or individually, from one or more heat-generating electronic components 224 of a computer electronic system is well known in the art. Essentially, the temperature of the electronic component is measured and, based upon the temperature, instructions in the form of a plurality of electrical signals are continuously or intermittently generated and used to control the operation and speed of the associated variable cooling fans 212. In a preferred embodiment of the present invention, the proportional flow control device 208 is adapted to increase or decrease the rate of flow of coolant fluid through the cold plate 222 in response to the same electrical signals used as instructions for controlling the variable cooling fans 212. In order to maintain an output of coolant fluid at a relatively stable temperature, the proportional flow control device 208 may be adapted to increase the rate at which coolant fluid is passed through the cold plate 222 in response to higher temperature readings generated by the electrical component 224. Conversely, cooler electrical components 224 will give off lower temperature readings which will initiate electrical signals to decrease the rate at which coolant fluid will be allowed to flow through the cold plate 222. The proportional flow control devices 208 may be calibrated to slow or speed the flow of coolant fluid across the electronic component, based upon the temperature of the electronic component and the thermal conductivity and specific heat capacity of the coolant fluid, in order to yield a heated output coolant fluid having the desired temperature.

For example, and not by way of limitation, the proportional flow control device 208 of the present invention may comprise a Posiflow® brand proportional solenoid valve coupled with an electronic control unit, both manufactured by Asco Valve, Inc. Such proportional flow control devices 208 allow flow rates to be adjustable between 0% to 100% with control achieved by applying straight voltage between 0 and 24 VDC via potentiometer or other variable power supply. Flow rates can also be regulated by a range of electrical inputs (sensors, transmitters, PLC, etc.) using the electronic control unit or similar control circuit.

On the supply side, coolant fluid is fed to a proportional flow control device 208 by fluid communication with a connected frame-level input assembly 210. Each frame-level input assembly 210 has a common inlet flow 206 and separate fluid connection (such as tubing) to each proportional flow control device 208 disposed on the frame 202. On the return side, heated coolant fluid exits a proportional flow control device 208 by a connected frame-level output assembly 211. Each frame-level output assembly 211 has a common outlet flow 207 and separate fluid connection (such as tubing) from each proportional flow control device 208 disposed on the frame 202.

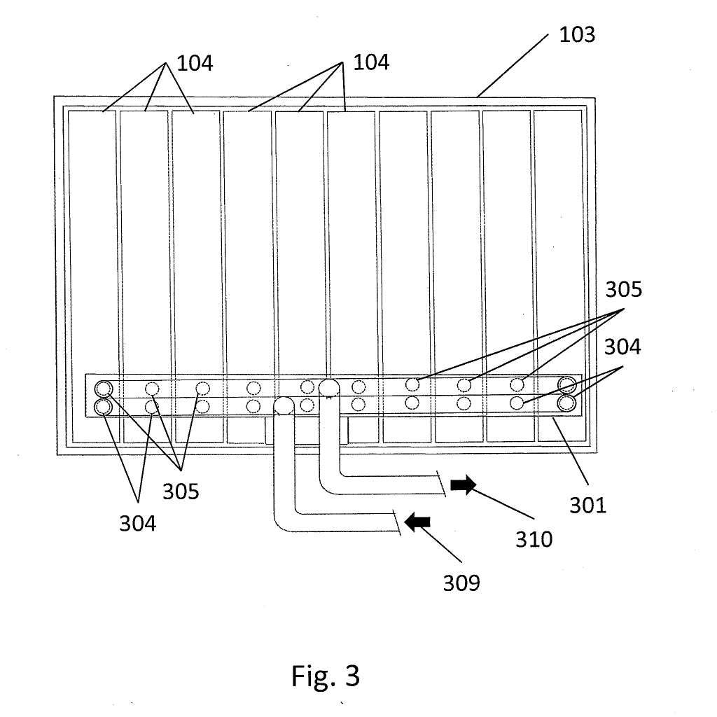

Frame-level input assembly 210 and frame-level output assembly 211 each terminate at a first side of dripless quick disconnect connector 203 to allow easy disconnection of the frame-level input assembly 210 and frame-level output assembly 211 from the chassis-level input assembly 310 and the chassis-level output assembly 311 (shown in FIG. 3). As illustrated in FIG. 2, the dripless quick disconnect 203 is preferably a dual disconnect having both an inlet port 204 and an exit port 205 so that all coolant fluid flow is substantially simultaneously halted for a blade frame 202 when it is disconnected. However, it is within the contemplation of the present invention that the frame-level input assembly 210 and frame-level output assembly 211 have separate dripless quick disconnect connectors 203, such as a separate input dripless quick disconnect connector (not shown) and an output dripless quick disconnect connector (not shown).

Dripless quick disconnect connectors 203 are well known in the art. Any suitable dripless quick disconnect connector capable of withstanding the temperatures and pressures of the cooling system may be utilized, the crux being the ability to readily remove a server blade 104 and the elements of the cooling system disposed thereon from the cooling system without interruption of the functioning of the remainder of the cooling system and without the spillage of any coolant fluid from the cooling system. Thus, as need dictates, one or more server blades 104 can be disconnected for repair, replacement, upgrade, cleaning or other maintenance without turning off or otherwise interrupting the operation of the cooling system as a while, and without the risk that liquid spilled from the coolant system may damage other sensitive electronic components 224.

Through the use of a proportional flow control device 208 associated with each cold plate 222, which, in turn, is associated with an individual heat generating electrical component 224, the temperature and pressure of the heated coolant fluid exiting the frame-level output assembly 211 may be maintained at a relatively stable and constant temperature and pressure. Appropriate control programming for the proportional flow control devices 208 may be implemented to combine the heated coolant fluid from different electrical components into a single heated coolant fluid flow having a temperature and pressure optimized for use as the heat source for a heat driven engine, such as a heat pump or adsorption chiller. Having a heated coolant flow at a substantially stable and constant temperature and pressure provides many benefits in the operation of heat driven engines. For example, the efficiency of a heat driven chiller when operated with hot water at 194° F. is 50% greater than if the hot water temperature is only 150° F.

In an alternate embodiment not shown in FIG. 2, the frame-level circulation assembly 217 may comprise a frame-level proportional flow control device in fluid connection with the frame-level output assembly 211 prior to the dripless quick disconnect connector 203 to regulate the collective output of heated coolant fluid from the cold plates 222 associated with all or a portion of the plurality of electronic components 224 disposed on the blade frame 202. The frame-level proportional flow control device may be utilized alone, as the only proportional flow control device for each frame 202, or it may be used in combination with the other proportional flow control devices 208 disposed on the frame 202. In such an alternate embodiment, appropriate programming is implemented to control the frame-level proportional flow control device disposed upon a given frame 202 based upon the electrical signals used to control the variable cooling fans 212 associated with that frame 202. Additional programming is also implemented to coordinate the frame-level proportional flow control devices disposed on multiple frames 202 and, indeed, all proportional flow control devices of the entire electronics system may be coordinated, all with the goal of yielding a heated coolant fluid having a relatively stable temperature and pressure for use as the source of driving heat to power a heat driven engine.

FIG. 3 is a schematic representation of a rear view of a chassis 103 having a chassis-level header assembly 301. Each chassis 103 carries multiple server blades 104. A chassis-level header assembly 301 according to the present invention is disposed proximate to the open rear of the chassis 103. Chassis-level header assembly 301 comprises one or more blade fluid inlet ports 304 which mate with the corresponding inlet port 204 of the dripless quick disconnect connector 203 of the frame-level input assembly 210 of each server 104 carried by the chassis 103. Each blade fluid inlet port 304 is in fluid communication with a chassis header inlet port 309, such as being connected by tubing.

Chassis-level header assembly 301 further comprises one or more blade fluid outlet ports 305 which mate with the corresponding outlet port 205 of the dripless quick disconnect connector 203 of the frame-level output assembly 211 of each server 104 carried by the chassis 103. Each blade fluid outlet port 305 is in fluid communication with a chassis header outlet port 310, such as being connected by tubing.

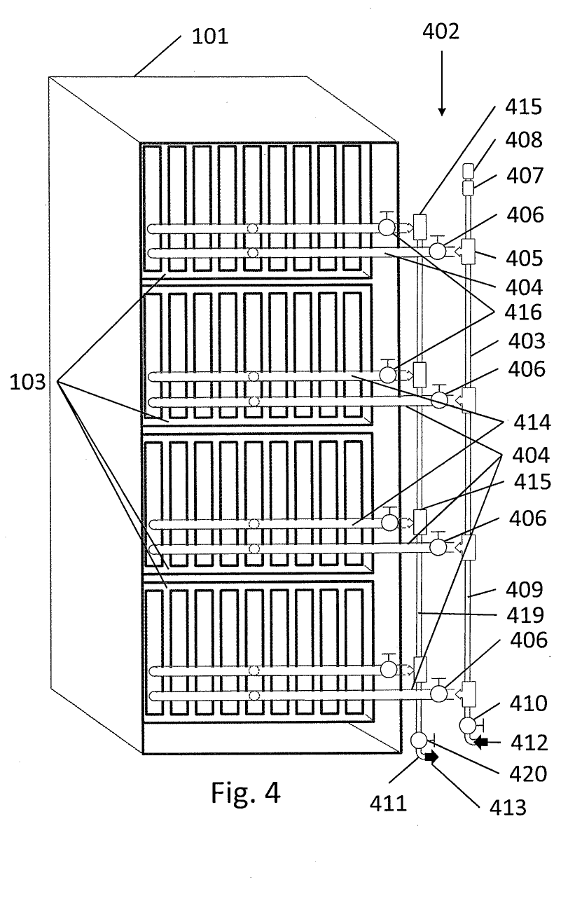

FIG. 4 is a schematic representation of a rear view of a server cabinet 101 having a cabinet-level header assembly 402. Each server cabinet 101 typically carries multiple chassis 103. A cabinet-level header assembly 402 according to the present invention is disposed proximate to the open rear of the cabinet 101. Cabinet-level header assembly 402 comprises a cabinet inlet header 403 and a cabinet return header 411. Cabinet inlet header 403 comprises one or more chassis inlet lines 404 which mate with the chassis header inlet port 309 of the chassis-level header assembly 301 of each chassis 103 carried by the cabinet 101. Each chassis inlet line 404 is in fluid connection with a cabinet header inlet port 412, such as being connected by cabinet header inlet tubing 409. Each chassis inlet line 404 may be equipped with a chassis inlet valve 406 to selectively open, close or partially restrict the flow of coolant fluid into the chassis inlet line 404. In a preferred embodiment, cabinet header inlet tubing 409 is joined with chassis inlet lines 404 through a corresponding inlet branch connection 405. The cabinet inlet header 403 is also preferably equipped with an inlet vacuum break valve 407 and an inlet air vent valve 408 to assist in the efficient flow of coolant fluid and for removal of entrapped air. Finally, a cabinet inlet header valve 410 may be provided on the cabinet inlet header 403 to selectively open, close or partially restrict the flow of coolant fluid into the cabinet inlet header 403 from the cabinet header inlet port 412.

Cabinet return header 411 comprises one or more chassis return lines 414 which mate with the chassis header outlet port 310 of the chassis-level header assembly 301 of each chassis 103 carried by the cabinet 101. Each chassis return line 414 is in fluid connection with a cabinet header return port 413, such as being connected by cabinet header return tubing 419. Each chassis return line 414 may be equipped with a chassis return valve 416 to selectively open, close or partially restrict the flow of coolant fluid into the chassis return line 414. In a preferred embodiment, cabinet header return tubing 419 is joined with chassis return lines 414 through a corresponding return branch connection 415. Finally, a cabinet header return valve 420 may be provided on the cabinet return header 411 to selectively open, close or partially restrict the flow of coolant fluid from the cabinet return header 411 to the cabinet header return port 413.

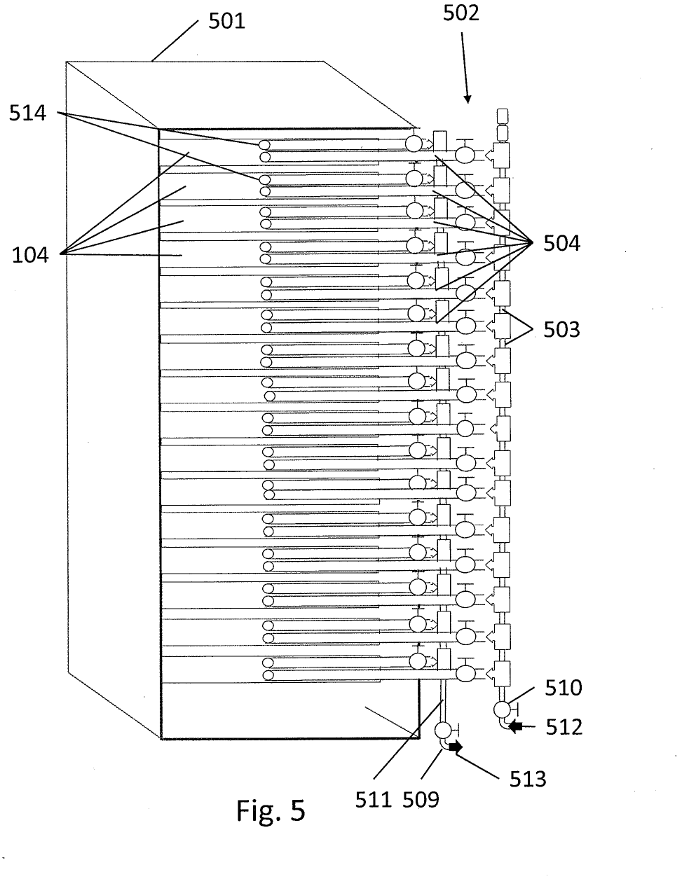

FIG. 5 illustrates an alternative cabinet 501 configuration having a plurality of server blades 104 held horizontally within the cabinet 501 and the associated alternative embodiment of a cabinet-level header assembly 502. In the illustrated embodiment, the cabinet inlet header 503 connects directly with the frame-level input assembly (210 shown in FIG. 2) of each of the plurality of server blades 104 via an associated blade inlet line 504. Likewise, the cabinet return header 511 connects directly with the frame-level output assembly (211 shown in FIG. 2) of each of the plurality of server blades 104 via an associated blade outlet line 514.

Cabinet inlet header 503 has a cabinet inlet header valve 510 to selectively open, close or partially restrict the flow of coolant fluid into the cabinet inlet header 503 from the cabinet header inlet port 512. Likewise, a cabinet header return valve 509 may be provided on the cabinet return header 511 to selectively open, close or partially restrict the flow of coolant fluid from the cabinet return header 511 to the cabinet header return port 513.

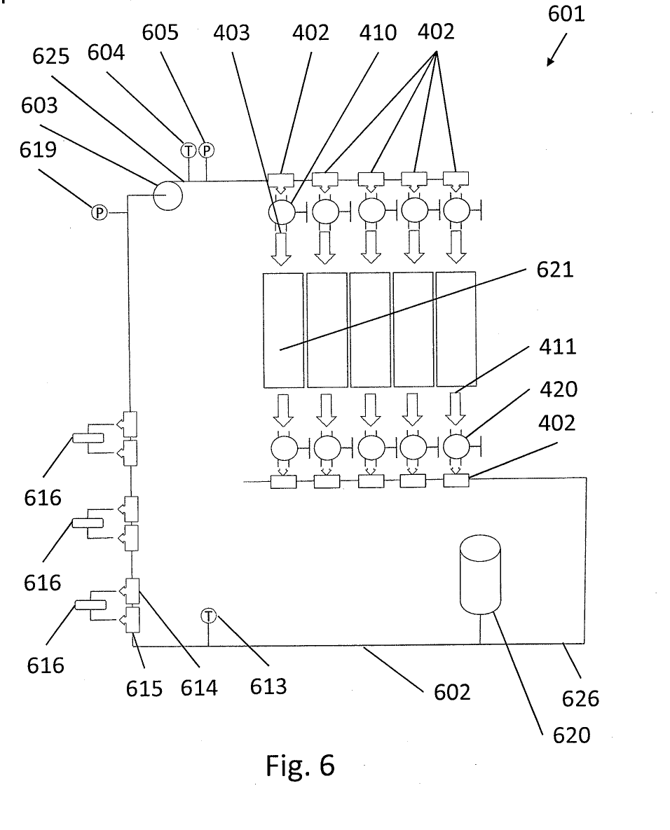

FIG. 6 is a schematic diagram of an embodiment of the liquid-based cooling system 601 of the present invention. The embodiment illustrated is a reverse return main loop circulation system, meaning that the first cabinet 621 on the coolant fluid supply side is the last cabinet 621 on the coolant fluid return side of the loop. Many alternate arrangements of circulation systems for the liquid-based cooling system 601 comprising interconnecting tubing configurations and a plurality of fluid-based heat exchangers such as liquid-cooled cold plates are within the contemplation of the present invention. The specific circulation system 601 configuration depends upon the different types of electronic components being cooled and the number of fluid-based heat exchangers affixed to the different electronic components.

The liquid-based cooling system 601 of the present invention provides a method of providing a heated coolant fluid, typically water, at a relatively constant temperature and pressure to one or more heat driven engines 616 by utilizing a proportional flow control device (not shown in FIG. 6) to optimize the output of a plurality of liquid-cooled cold plates (not shown in FIG. 6) operatively mounted on a plurality of heat-producing electronic components (not shown in FIG. 6).

The liquid-based cooling system 601 comprises a main circulation loop 602. Main circulation loop 602 further comprises a trunk supply line 625, a trunk return line 626, and one or more main circulation pumps 603 to circulate and carry the coolant fluid through the cooling system 601. Main circulation pump 603 preferably comprises a variable speed pump controllable to provide a constant pressure on the supply or output side of the pump 603. Trunk supply line 625 is connected for fluid communication to the cabinet header inlet port 412 of the cabinet inlet header 403 of one or more cabinet-level header assemblies 402 by a valve, such as cabinet header inlet valve 410. Trunk return line 626 is connected to the cabinet return header 411 of one or more cabinet-level header assemblies 402 by a valve, such as cabinet return header valve 420. Cabinet header inlet valve 410 and cabinet return header valve 420 allow each cabinet 101 to be isolated from the cooling system 601 as needed.

Each cabinet-level header assembly 402 supplies coolant as described above to the cold plates (not shown) on the electronic components (not shown) of the associated cabinet 101. Heated coolant fluid flows out of the cabinet return header 411 of the cabinet-level assembly 402 to the connected trunk return line 626.

Trunk return line 626, containing the combined heated coolant fluid output of all of the connected cabinets 101, is connected to one or more heat driven engines 616. Heated coolant fluid flows through trunk return line 626 and feeds heated coolant to the heat driven engines 616, the temperature and pressure of such heated coolant fluid having been optimized for use as the driving heat for powering the heat driven engines 616 by coordinated application of the proportional flow control devices (not shown) of the cooling system 601. Heat driven engines 616 may comprise a heat driven chiller, a heat driven heat pump, or any other heat driven engine which may be adapted to be driven by a heated coolant fluid. Each heat driven engine 616 is in fluid communication with trunk return line 626 of the cooling system 601 through a supply connection 615 and a return connection 614. In an alternate preferred embodiment, the heat driven engines 616 are adapted to be driven by heated coolant fluid output of the cooling system 601 without being in fluid communication with the cooling system 601. In such an embodiment, the coolant fluid of the liquid-based coolant system 601 is isolated from the coolant utilized in the operation of the heat driven engine 616, with a common heat exchanger (not shown), the operation of which is well known in the art, being used to transfer the heat from the heated coolant fluid carried by the trunk return line 626 to the coolant utilized to drive the heat driven engine 616.

To facilitate operation, the main circulation loop 602 is equipped with one or more temperature sensors, such as supply side temperature sensor 604 and return side temperature sensor 613. Similarly, the cooling system 601 is equipped with one or more pressure sensors, such as supply side pressure sensor 605 and return side pressure sensor 619. Similarly, one or more pressure tanks 620 may be in fluid communication with the main circulation loop 602 to assist in the efficient circulation of coolant fluid.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A liquid-based cooling system for cooling an electronics system of the type having multiple heat generating electronic components disposed upon a plurality of frames, said cooling system comprising:
(a) a plurality of liquid-cooled cold plates, at least one of such liquid-cooled cold plates operatively mounted on each heat generating electronic components to be cooled;
(b) a plurality of proportional flow control devices, at least one of such proportional flow control devices in fluid communication with each of the liquid-cooled cold plates for controlling the flow of a coolant fluid through the liquid-cooled cold plate;
(c) a main circulation loop in fluid communication with each of said liquid-cooled cold plates for carrying coolant fluid; and
(d) a heat driven engine adapted to be driven by heated coolant fluid supplied through the main circulation loop.

2. The liquid-based cooling system of claim 1 wherein said main circulation loop further comprises a frame-level circulation assembly connected to the main circulation loop by a dripless quick disconnect connector.

3. The liquid-based cooling system of claim 1 wherein said proportional flow control device comprises an electro-mechanical proportional control valve.

4. The liquid-based cooling system of claim 1 wherein said proportional flow control device comprises a solid state proportional control valve.

5. The liquid-based cooling system of claim 1 wherein said heat driven engine further comprises an adsorption chiller.

6. The liquid-based cooling system of claim 1 wherein said heat driven engine further comprises a heat pump.

7. A liquid-based cooling system for cooling an electronics system of the type having multiple heat generating electronic components disposed upon a plurality of frames, said cooling system comprising:
(a) a main circulation loop for carrying coolant fluid between a heat sink and a plurality of frame-level circulation assemblies, each frame-level circulation assembly being associated with one of said plurality of frames;
(b) each said frame-level circulation assembly comprising a frame-level input assembly and a frame-level output assembly, wherein said frame-level input assembly is in fluid communication with a plurality of liquid-cooled cold plates, at least one of such liquid-cooled cold plates operatively mounted on each heat generating electronic components to be cooled, and wherein said frame-level output assembly is in fluid communication with said plurality of liquid cooled cold plates;
(c) wherein said frame-level input assembly is connected to the main circulation loop by a dripless quick disconnect connector; and
(d) wherein said frame-level output assembly is connected to the main circulation loop by a dripless quick disconnect connector.

8. The liquid-based cooling system of claim 7 wherein each said frame-level circulation assembly further comprises a plurality of proportional flow control devices, at least one of such proportional flow control devices in fluid communication with each of the liquid-cooled cold plates for controlling the flow of coolant fluid through the liquid-cooled cold plate.

9. The liquid-based cooling system of claim 7 wherein each said frame-level output assembly further comprises a proportional flow control device in fluid communication with each of the liquid-cooled cold plates between the liquid-cooled cold plates and the dripless quick disconnect connector.

10. The liquid-based cooling system of claim 7 wherein said heat sink further comprises a heat driven engine adapted to be driven by heated coolant fluid flowing through the cooling system.

11. The liquid-based cooling system of claim 10 wherein said heat sink further comprises an adsorption chiller.

12. The liquid-based cooling system of claim 10 wherein said heat sink further comprises a heat pump.

13. The liquid-based cooling system of claim 8 wherein said proportional flow control device comprises an electro-mechanical proportional control valve.

14. The liquid-based cooling system of claim 9 wherein said proportional flow control device comprises a solid state proportional control valve.

15. A method of supplying a heated coolant fluid to drive a heat driven engine at a substantially constant temperature and pressure using waste heat from an electronics system of the type having multiple heat generating electronic components disposed upon a plurality of frames as a heat source, said method comprising the steps of:
(a) circulating a coolant fluid through a liquid-based cooling system, said cooling system comprising:
a main circulation pump for moving coolant fluid through the cooling system;
(ii) a heat driven engine adapted to be driven by heated coolant fluid flowing through the cooling system;
(iii) a trunk supply line for carrying coolant fluid from the heat driven engine to a plurality of liquid-cooled cold plates, each of such liquid-cooled cold plates operatively engaged with a heat generating electronic component;
(iv) a plurality of proportional flow control devices, each of such proportional flow control devices in fluid communication with at least one of said liquid-cooled cold plates to regulate the flow of coolant fluid through said liquid-cooled cold plate; and
(v) a trunk return line for carrying heated coolant fluid from the liquid-cooled cold plates to the heat driven engine;
(b) measuring the temperature of each of such heat generating electronic components;
(c) adjusting the flow of coolant fluid through each of said liquid-cooled cold plates based upon the temperature of the associated electronic component to produce a heated coolant fluid output having a substantially constant temperature; and
(d) combining the heated coolant fluid outputs from all of liquid-cooled cold plates to produce a combined heated coolant fluid output having a substantially constant temperature, said combined heated coolant fluid output to be supplied through the trunk return line to drive the heat driven engine.
